(19) United States
(12) Patent Application Publication
(10) Pub. No.: US 2015/0073964 A1
(43) Pub. Date: Mar. 12, 2015

(54) MARKET DATA HANDLING BASED ON DERIVATIVE CONTRACT SPECIFICATIONS

(71) Applicants: Andy Peichl, Ubstadt-Weiher (DE); Ingo Siebeking, Heidelberg (DE); Jelena Wevelsiep-Djokic, Karlsruhe (DE); Sacha Droste, Wiesloch (DE); Manfred Crumbach, Wiesloch (DE); Santo Bianchino, Schifferstadt (DE); Klaus Mueller, Neustadt (DE); Claudia Volke, Ostringen (DE)

(72) Inventors: Andy Peichl, Ubstadt-Weiher (DE); Ingo Siebeking, Heidelberg (DE); Jelena Wevelsiep-Djokic, Karlsruhe (DE); Sacha Droste, Wiesloch (DE); Manfred Crumbach, Wiesloch (DE); Santo Bianchino, Schifferstadt (DE); Klaus Mueller, Neustadt (DE); Claudia Volke, Ostringen (DE)

(73) Assignee: SAP AG, Walldorf (DE)

(21) Appl. No.: 14/025,097

(22) Filed: Sep. 12, 2013

(51) Int. Cl. G06Q 40/04

(52) U.S. Cl. CPC G06Q 40/04
USPC 705/37

(57) ABSTRACT

In an example embodiment a market data management system allows users to track information regarding commodities. A representative market data management system comprises physical commodity objects including a plurality of fields that describe a real world commodity, market identifier objects including market identifier codes, and contract specification objects including a plurality of fields that describe a derivative contract specification for a particular commodity traded at a particular commodity market. In the data model, a one to many relationship may exist for a physical commodity object and contract specification objects (e.g., a given commodity may be traded according to different derivative contract specifications). The data model may also allow a many to many relationship between contract specification objects and market identifier objects (e.g., a given market may have multiple derivative contract specifications and/or a given derivative contract specification may have the same terms at different markets).

### TECHNICAL FIELD

This disclosure relates to modeling real world events. More particularly, this disclosure relates to a system and data model for collecting information about commodity trading.

### BACKGROUND

Manufacturing businesses typically require raw materials to produce products. Sometimes these raw materials are obtained through a commodity market. Other business may not directly trade in commodity raw materials, but may watch commodity trading to obtain information to make business decisions. It may thus be important to track commodity trading information.

### BRIEF DESCRIPTION OF DRAWINGS

FIG. 1 illustrates commodity trading and providing information to business decision makers.

FIG. 2 illustrates a representative data model for tracking commodity trading.

FIG. 3 illustrates relationships between a representative user interface and a representative data model.

FIG. 4 illustrates a representative user interface according to one embodiment.

FIG. 5 illustrates a representative user interface according to one embodiment.

FIG. 6 illustrates a representative user interface according to one embodiment.

FIG. 7 illustrates representative mechanisms for entering pricing information.

FIG. 8 is a block diagram of a computer processing system, within which a set of instructions for causing the computer to perform any one or more of the methodologies discussed herein may be executed.

### DETAILED DESCRIPTION

The description that follows includes illustrative systems, methods, techniques, instruction sequences, and computing machine program products of illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

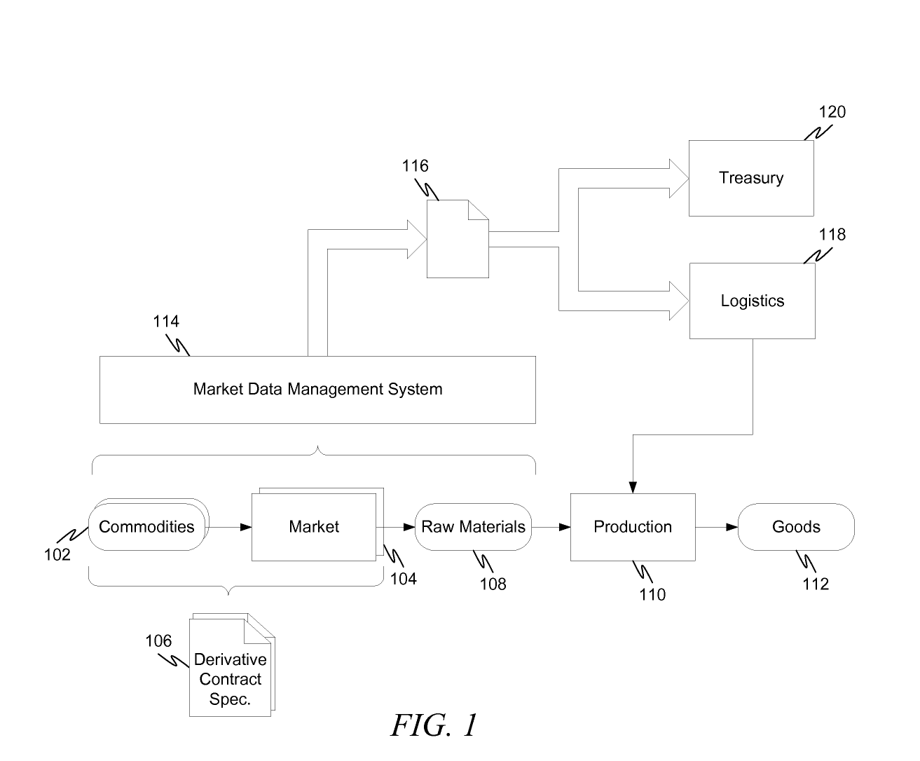

FIG. 1 illustrates commodity trading and providing information to business decision makers. Commodities 102 are traded at a market 104 usually according to a derivative contract specification 106. Commodities refer to materials or products and may include harvested products like wheat, coffee, cocoa, sugar, corn, soybeans, fruit, etc., extracted materials like metals, rubber, oil, etc. or processed or produced products like pork bellies, recycled steel, etc. Sometimes commodities may be grouped into large classes such as energy, agricultural including livestock, precious metals, industrial metals, etc. A commodity market is defined by physical or virtual transactions of buying and selling involving commodities. Often such transactions are accomplished using a financial derivative meaning a financial instrument whose value is derived from a commodity. Financial derivatives include forward contracts (an agreement between two parties to exchange at some fixed future date a given quantity of a commodity at a price defined today), futures contracts (a standardized forward contract in which the buyer and the seller accept the terms in regards to product, grade, quantity and location and are only free to negotiate the price), swaps (an agreement where parties exchange cash flows of one party's financial instrument for those of another party's financial instrument), options (the right, but not the obligation, to purchase a commodity in the future at a price fixed today), and so forth. Examples of commodity markets include Chicago Mercantile Exchange (CME), the London Metal Exchange (LME), etc. A derivative contract specification 106 defines the terms of the transaction (e.g., a futures contract).

Once raw materials 108 are obtained, production 110 may product goods 112 that are sold by a business. Often, there are fixed (or reasonably fixed) production costs, goods are sold at a fixed price, but raw materials can fluctuate, depending on what is happening in the commodities market 104. To minimize business risk, many companies have departments that track purchases, market variations, and so forth. These departments rely on information regarding the company and/or market activities. In FIG. 1, these departments are represented by treasury 120. Additionally, in many companies logistics departments 118 such as purchasing, etc. actually manage and/or purchase materials. These departments may also need information about purchases actually made and/or market activities. FIG. 1 illustrates a market data management system 114 that can capture and track such information and provide appropriate information 116 to both treasury 120 and logistics 118, allowing them to coordinate more effectively.

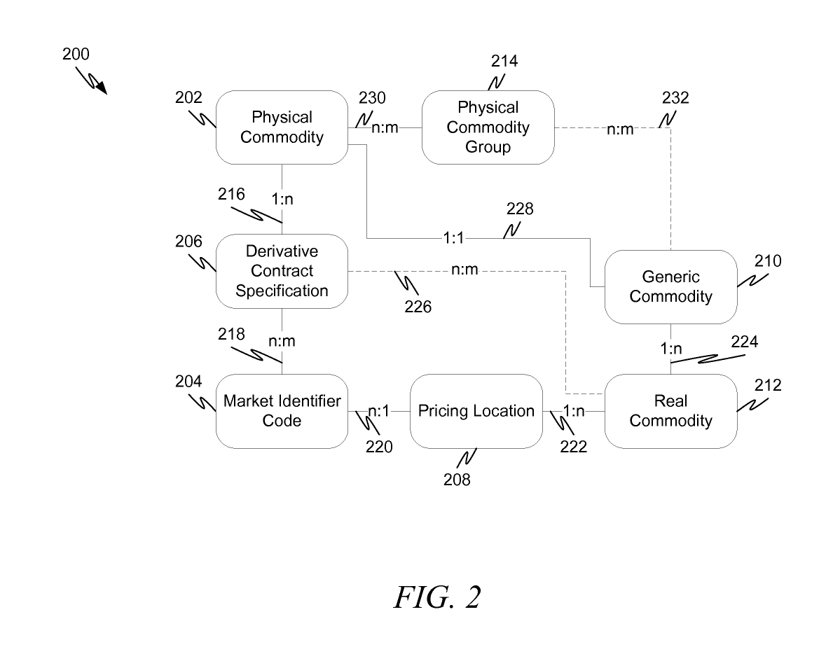

FIG. 2 illustrates a representative data model 200 for tracking commodity trading. This data model may be used, for example, by the market data management system 114 of FIG. 1. The data model 200 is designed to not only make it easy to represent real world commodities, commodity markets, derivative contract specifications, trades, etc. but also to easily capture real world data to make it easy to set up and maintain the information in the system.

The data model 200 may include a plurality of objects (e.g., physical commodity object 202, contract specification object 206, etc.). In this disclosure, object means a location in storage (memory, disk, etc.) having a value and referenced by an identifier. Objects may be a variable, function, or a data structure, such as a data table or other structure. It may also refer to a particular instance of an object class.

The data model 200 may include physical commodity object 202. The physical commodity object 202 may comprise a plurality of data fields to represent the underlying commodity that is traded. For example, the fields may comprise a physical commodity name (e.g., the name of the physical commodity used in the object), a physical commodity description, and a physical commodity unit of measure. The physical commodity name may be created and/or modified by a user and/or may be selected from a drop down list or some combination thereof. The physical commodity name may be used in the system to refer to the underlying commodity. The physical commodity description may contain text, other descriptive information, or combinations thereof. The physical commodity unit of measure may be a unit of measure used to trade the commodity, such as tons, barrels, metric tons, and so forth.

The data model 200 may also include a market identifier object 204. The market identifier object 204 may comprise one or more data fields to represent a commodity market. Commodity markets have Market Identifier Codes (MIC) that uniquely identify them. These MIC are published in the ISO 10383 standard. For example, the London Metal Exchange has the MIC of XLME and the CME Globex has the MIC of GLBX. Additional fields may include a description field containing text, other descriptive information, or combinations thereof, a country field containing an identifier of the country where the commodity market is located, a city field containing an identifier of the city where the market is located, a status field containing status information such as active, inactive, etc. to identify the status of the market, a URL for the market, the trading platform (electronic, open outcry, etc.), and so forth.

The data model may also include a contract specification object 206. A contract specification object 206 may include a plurality of fields that identify information from a derivative contract specification. A derivative contract specification identifies the terms of the transaction. Depending on the type of derivative contract specification, it may include such information such as the underlying commodity, the grade of the underlying commodity, the product symbol, the market the derivative contract applies to, the hours of the market, the contract unit or lot size (e.g., the quantity of the commodity to be traded, the option to be purchased, and so forth), the currency units for price quotation (e.g., US dollars, US dollars and cents), clearable currencies (e.g., what currencies are acceptable for settling the contract), minimum price fluctuation per unit (e.g., the “tick size” or quantized change of price such as $10.00 US, $0.50 US, and so forth), the last trading day (e.g., last day for trading a particular contract), the settlement type (e.g., physical), location of settlement, delivery terms (location, time period, and so forth), and other information. A contract specification object 206 may include data fields to capture some or all of this information. Some data in the derivative contract specification like contract size, or quotation unit of measure are time dependent, and can be changed by an exchange from time to time.

It should be noted that a derivative contract specification is particular to a given market or set of markets. Thus, the information in a particular derivative contract specification may not only depend on the type of derivative contract specification, but also on the commodity market and the underlying commodity. In accordance with this, the data fields of a particular contract specification object 206 may vary somewhat by the commodity market, the type of derivative contract specification, the underlying commodity, or combinations thereof.

A given market has a plurality of derivative contract specifications for a plurality of commodities. A given derivative contract specification may apply to a plurality of markets. A given commodity may be traded according to a plurality of derivative contract specifications. Thus, the data model 200 may account for these possibilities. A single physical commodity object 202 may be associated with multiple contract specification objects 206 as indicated by the 1:n relationship link 216. A single contract specification object 206 may be associated with multiple market identifier objects 204 and a single market identifier object 204 may be associated with multiple contract specification objects 206 as indicated by the n:m relationship link 218.

Relationships between a physical commodity object 202, a contract specification object 206 and a market identifier object 204 may uniquely define a particular commodity traded at a particular market according to a particular derivative contract specification. Thus, such a combination may be used to track information about a particular commodity traded at a particular market according to a particular derivative contract specification.

In some embodiments, the data model 200 of FIG. 2 may also comprise a pricing location object 208. As previously discussed, a market identifier object 204 may include a country field that contains an identifier of the country where the commodity market is located, a city field containing an identifier of the city where the market is located, and other fields. The fields that relate to pricing location may be placed into a pricing location object 208, if desired. In many instances, a given location (country, city) may have different markets such as an electronic market and an open call market, each with its unique MIC. In those embodiments that use a pricing location object 208, placing the location information into a pricing location object 208 allows a single pricing location object 208 to be associated with all market identifier objects 204 relating to that particular location as indicated by the n:1 relationship link 220.

Additionally, in some embodiments the commodity object hierarchy may be a bit more detailed if desired with a generic commodity object 210 representing the general commodity (oil, copper, wheat, etc.) and a real commodity object 212 representing a specific commodity (such as a particular grade of oil, copper, wheat, etc.) as represented by the 1:n relationship link 224. The real commodity object 212 may then be associated in a 1:n type of relationship 222 with a pricing location object 208 (e.g., multiple commodities at a particular pricing location). Since a real commodity object 212 may represent a particular grade of commodity, it is similar (or has similar information to) a contract specification object 206. Thus, there may be an effective logical (rather than actual) link between a real commodity object 212 and a contract specification object 206 as indicated by the logical n:m relationship link 226.

Since the particular grade of commodity is represented in the contract specification object 206 when coupled with a physical commodity object 202, the physical commodity object 202 is effectively a generic commodity and for those embodiments that use a generic commodity object 210, a 1:1 relationship 228 may exist between a physical commodity object 202 and a generic commodity 210.

Finally commodity objects may be collected into a physical commodity group object 214. A given commodity may belong to multiple groups and a given group may have multiple commodities. Thus, an n:m relationship link 230 may exist between a physical object 202 and a physical commodity group object 214. This creates an effective logical (rather than actual) link between a physical commodity group object 214 and a generic commodity object 210 as indicated by logical n:m relationship link 232.

In one embodiment, pricing location object 208, real commodity object 212 and generic object 210 may comprise existing data models of the embodiment and the relationship links between them and physical commodity object 202, contract specification object 206 and market identifier object 204 may represent integration of an existing data model with a new data model comprising physical commodity object 202, contract specification object 206 and market identifier object 204. In other embodiments, there may be no existing data model and desired commodity and market information may be represented by a data model comprising physical commodity object 202, contract specification object 206 and market identifier object 204.

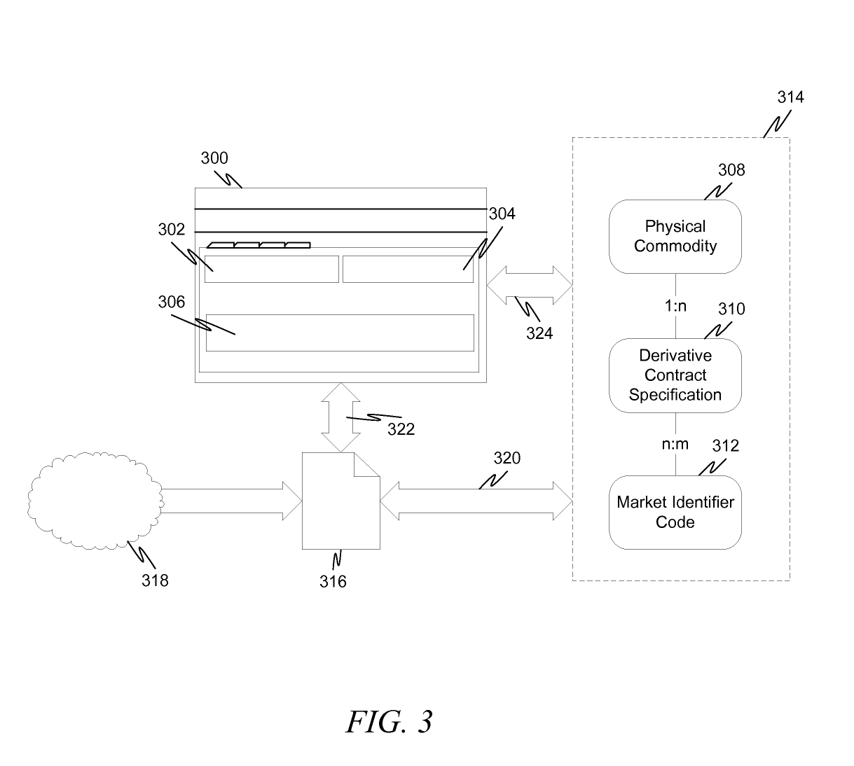

FIG. 3 illustrates relationships between a representative user interface 300, information received or retrieved from a network 318, and a representative data model 314. A market data management system (such as market data management system 114 of FIG. 1) may have different mechanisms to help enter and maintain information utilized in conjunction with a data model 314. In some embodiments it may be desirable to employ automatic data entry. In such a situation, information 316 may be retrieved from a network 318. For example derivative contract specifications for appropriate commodities may be retrieved from websites that publish derivative contract specifications of interest. In such embodiments, information 316 may represent the derivative contract specifications. Information in such derivative contract specifications may be “scraped” or otherwise extracted in an automated fashion. For example, website pages containing appropriate derivative contract specifications maybe downloaded and the html associated with the webpage parsed to identify information of interest and the information of interest may be extracted.

Table 1 below may represent, for example, some information associated with a derivative contract specification for crude oil traded on the CME Globex market that may be obtained from a web page containing the appropriate derivative contract specification. The information is not meant to be exhaustive, simply illustrative, so actual derivative contracts may have either more or less information accordingly.

From this table (perhaps included in a web page), key information may be extracted, such as the commodity (crude oil), a description (light sweet crude oil), a product symbol (CL), a market (CME Globex), the contract unit (1,000 barrels), price quotation currency (dollars and cents per barrel), the “tic” size ($0.01 per barrel), special rules, such as limits on price fluctuation ($10.00 per barrel), the type of settlement (physical), and various delivery information. Such information may be placed in the appropriate data objects of data model 314.

By way of example, an appropriate physical commodity object 308 may be created and appropriate fields such as a physical commodity name (crude oil), a physical commodity description (light sweet crude oil), and a physical commodity unit of measure (barrel) may be populated. An appropriate contract specification object 310 may also be created and appropriate fields, such as the underlying commodity (crude oil), the grade of the underlying commodity (light sweet crude oil), the product symbol (CL), the market the derivative contract applies to (CME Globex), the lot size (1,000 barrels), the currency units for price quotation (US dollars and cents), tic size ($0.01 per barrel), the settlement type (physical), delivery terms (location, time period, and so forth) may be populated. Note that fields such as the underlying commodity and commodity grade may not reside in the contract specification object 310, but may be part of the physical commodity object 308 and a link may be established between the two objects (310, 308) to define that information.

TABLE 1
Light Sweet Crude Oil Futures

| | |
|---|---|
| Product Symbol | CL |
| Venue | CME Globex, CME ClearPort, Open Outcry (New York) |
| Contract Unit | 1,000 barrels |
| Price Quotation | U.S. Dollars and Cents per barrel |
| Minimum | $0.01 per barrel |
| Fluctuation | Initial Price Fluctuation Limits for All Contract Months. At the |
| | commencement of each trading day, there shall be price |
| | fluctuation limits in effect for each contract month of this futures |
| | contract of $10.00 per barrel above or below the previous day's |
| | settlement price for such contract month. If a market for any of |
| | the first three (3) contract months is bid or offered at the upper or |
| Maximum Daily | lower price fluctuation limit, as applicable, on Globex it will be |
| Price Fluctuation | considered a Triggering Event which will halt trading for a five |
| | (5) minute period in all contract months of the CL futures |
| | contract, as well as all contract months in all products cited in the |
| | Associated Products Appendix of rule 200.06. Trading in any |
| | option related to this contract or in an option contract related to |
| | any products cited in the Associated Products Appendix which |
| | may be available for trading on either Globex or on the Trading |
| | Floor shall additionally be subject to a coordinated trading halt. |
| Settlement Type | Physical |
| | Delivery shall be made free-on-board (“F.O.B.”) at any pipeline |
| | or storage facility in Cushing, Oklahoma with pipeline access to |
| | Enterprise, Cushing storage or Enbridge, Cushing storage. |
| | Delivery shall be made in accordance with all applicable Federal |
| | executive orders and all applicable Federal, State and local laws |
| | and regulations. |
| Delivery | At buyer's option, delivery shall be made by any of the following |
| | methods: (1) by interfacility transfer (“pumpover”) into a |
| | designated pipeline or storage facility with access to seller's |
| | incoming pipeline or storage facility; (2) by in-line (or in-system) |
| | transfer, or book-out of title to the buyer; or (3) if the seller |
| | agrees to such transfer and if the facility used by the seller allows |
| | for such transfer, without physical movement of product, by in- |
| | tank transfer of title to the buyer. |
| Delivery Period | (A) Delivery shall take place no earlier than the first calendar day |
| | of the delivery month and no later than the last calendar day of |
| | the delivery month. |
| | (B) It is the short's obligation to ensure that its crude oil receipts, |
| | including each specific foreign crude oil stream, if applicable, are |
| | available to begin flowing ratably in Cushing, Oklahoma by the |
| | first day of the delivery month, in accord with generally accepted |
| | pipeline scheduling practices. |
| | (C) Transfer of title-The seller shall give the buyer pipeline |
| | ticket, any other quantitative certificates and all appropriate |
| | documents upon receipt of payment. |

Thus, by obtaining information 316 such as derivative contract specifications from network 318, the information may be parsed and appropriate data objects may be created and fields in those data objects populated in an automated fashion as indicated by arrow 320.

Rather than automatically creating and populating appropriate data objects, information may be entered from the retrieved information 316 through an appropriate user interface 300. An appropriate user interface 300 may take a variety of forms, but such an interface may typically have a plurality of regions 302, 304, 306 where information may be displayed, entered, and/or combinations thereof. As information is entered, appropriate data objects may be created and fields populated as indicated by arrow 324. To the extent that information already exists in the system, it need not be reentered, simply retrieved and/or linked to. As an example, if a market identifier object has already been crated for CME Globex, the object may simply be linked to in an appropriate manner.

Combinations of the automatic creation/population and user interface approaches may also be used. This is indicated by arrow 322. As an example, suppose appropriate physical commodity object 308 and market identifier object 312 already exist. Also suppose that a derivative contract specification for the commodity described in physical commodity object 308 from the market described in market identifier object 312 is retrieved as information 316. Further suppose that parsing the retrieved information 316 identified the commodity associated with the physical commodity object 308 and the market associated with market identifier object 312. The information in these objects (308, 312) may be retrieved and placed in the appropriate locations in use interface 300 to “pre-populate” the user interface 300 with information that already exists in the system. Furthermore, other information retrieved from the derivative contract specification may be populated into user interface 300 to aid in entry of the appropriate information.

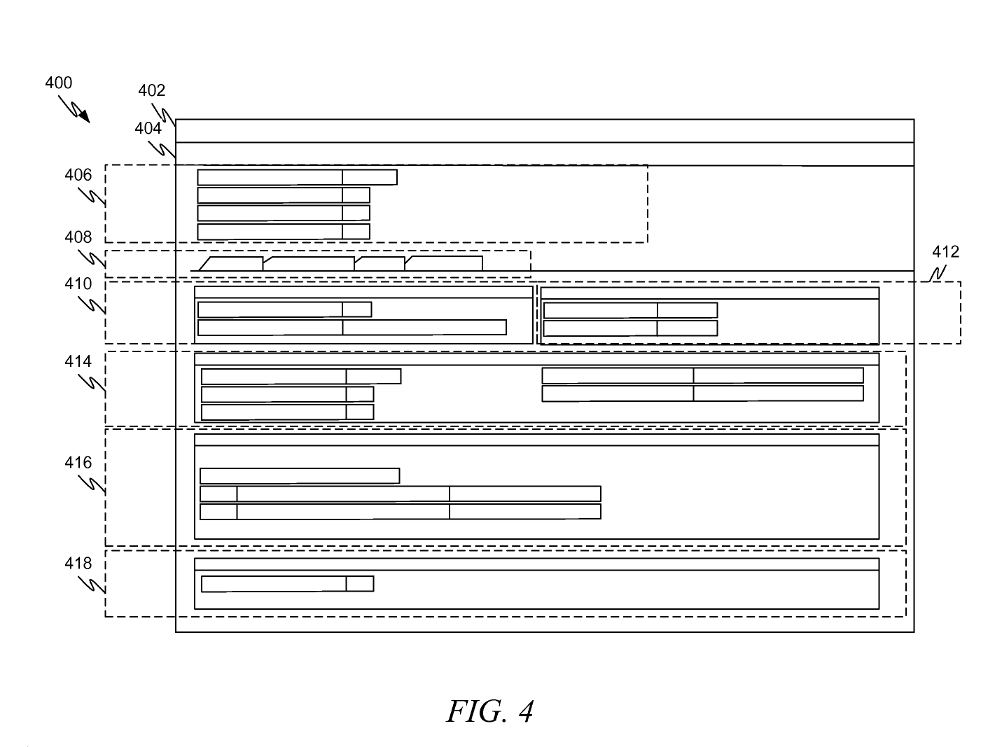

FIG. 4 illustrates a representative user interface 400 according to one embodiment. The user interface 400 may be used, for example, in entering and/or displaying information associated with a derivative contract specification. The representative user interface may comprise a plurality of regions, 402, 404, 406, 408, 410, 412, 414, 416, and 418. Some regions may contain information related to one or more objects, such as a physical commodity object 308, contract specification object 310, and/or market identifier object 312 of FIG. 3.

Region 402 may comprise a title, such as a window title. If the user interface 400 is used to display or enter information about a derivative contract specification, the title may be something like “Display Derivate Contract Specification.”

Region 404 may comprise a plurality of icons, text labels, and/or combinations thereof that indicate various actions a user may take. Representative actions may include functions like “create” to create a new derivative contract specification, “save” to save the information into the appropriate object(s), “copy” to copy the information to a different location, etc.

Region 406 may comprise a plurality of fields that identify the contract specification object such as a derivative contract specification identifier field to identify the contract specification object, a description field containing a description of the derivative contract, a derivative category field containing the type of derivative contract (such as futures, option, etc.), a status field containing the status of the contract specification object (e.g., released, etc.). In one embodiment, region 406 may be continuously displayed even if other regions of the user interface change when, for example, a new tab is selected as described below. However, this may not be reflected in all embodiments.

Region 408 may comprise a plurality of tab controls that cause different regions containing different fields to be displayed in the area underneath the tabs. One tab may be highlighted, brought to the front, and/or otherwise distinguished from the other tabs to indicate which tab is being displayed in the remainder of the regions of the display. In one embodiment, the tabs may contain basic data, derivative details, periods, and administration. Some of these are described in conjunction with other figures below. When the basic data tab is selected, region 410, 412, 414, 416, 418 and/or combinations thereof may be displayed. Each region may contain a title indicating the information displayed in the region.

Region 410 may contain general data, such as a filed containing a product symbol and a URL for the contract specification. Labels and/or descriptive text may also be displayed, along with a title indicating the data in the region.

Region 412 may contain information about the physical commodity such as a physical commodity name (e.g., the name of the physical commodity used in a physical commodity object in the system), a physical commodity unit of measure and/or combinations thereof. Labels and/or descriptive text may also be displayed, along with a title indicating the data in the region.

Region 414 may contain information related the determination method associated with the derivative contract specification. Each market has rules for derivative contract determination such as when the commodity can be traded according to the contract, the contract period, the settlement period, the quotation period, etc. The information in the region 414 may be used by a market data management system to calculate this information. In an example embodiment, region 414 may include the market rules to be used in the period determination (e.g., London Metal Exchange, CME Globex, etc.), the security identifier determination (e.g., manual input or with pattern YYYYMMDD), the prompt date calendar to be used (e.g., the calendar used by the London Metal Exchange), the logic to be used for the expiration date (e.g., the last trading day or the last quotation date), the logic to be used for the reporting date (e.g., the last trading day, the last contact date), and/or combinations thereof. Labels and/or descriptive text may also be displayed, along with a title indicating the data in the region.

Region 416 may contain market identifier code information, such as the market identifier code of a selected market identifier object(s) (since multiple market identifier objects may be linked to a single contract specification object according to a data model like model 314 of FIG. 3), or a list of relevant market identifier codes. Labels and/or descriptive text may also be displayed, along with a title indicating the data in the region.

Region 418 may contain a field related to archiving market data such as a retention period field indicating the time frame for which market data should be retained in the system. Labels and/or descriptive text may also be displayed, along with a title indicating the data in the region.

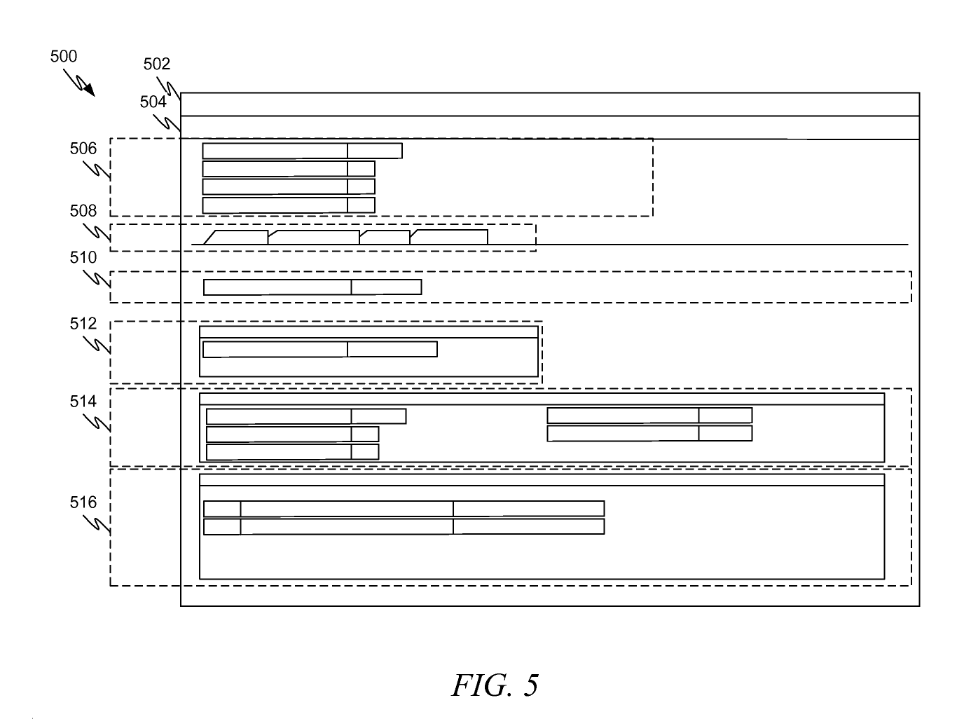

FIG. 5 illustrates a representative user interface 500 according to one embodiment. The user interface 500 may be used, for example, in entering and/or displaying information associated with a derivative contract specification. The representative user interface may comprise a plurality of regions, 502, 504, 506, 508, 510, 512, 514, and/or 516. Some regions may contain information related to one or more objects, such as a physical commodity object 308, contract specification object 310, and/or market identifier object 312 of FIG. 3.

Region 502 may be substantially similar to region 402 of FIG. 4 and may comprise a title, such as a window title. If the user interface 500 is used to display or enter information about a derivative contract specification, the title may be something like “Display Derivate Contract Specification.”

Region 504 may be substantially similar to region 404 of FIG. 4 and comprise a plurality of icons, text labels, and/or combinations thereof that indicate various actions a user may take. Representative actions may include functions like “create” to create a new derivative contract specification, “save” to save the information into the appropriate object(s), “copy” to copy the information to a different location, etc. Some or all of the icons/text labels displayed and actions may be different from those in region 404 to represent functionality that applies to regions 506, 508, 510, 512 and/or 514.

Region 506 may be substantially similar to region 406 of FIG. 4 and may comprise a plurality of fields, labels, and/or descriptive text that identify the contract specification object such as a derivative contract specification identifier field to identify the contract specification object, a description field containing a description of the derivative contract, a derivative category field containing the type of derivative contract (such as futures, option, etc.), a status field containing the status of the contract specification object (e.g., released, etc.). In one embodiment, region 506 may be continuously displayed even if other regions of the user interface change when, for example, a new tab is selected as described below. However, this may not be reflected in all embodiments.

Region 508 may be substantially similar to region 408 of FIG. 4 and may comprise a plurality of tab controls that cause different regions containing different fields to be displayed in the area underneath the tabs. One tab may be highlighted, brought to the front, and/or otherwise distinguished from the other tabs to indicate which tab is being displayed in the remainder of the regions of the display. In one embodiment, the tabs may contain basic data, derivative details, periods, and administration. Some of these are described in conjunction with other figures below. When the derivative detail tab is selected, region 510, 512, 514, 516 and/or combinations thereof may be displayed. Each region may contain a title indicating the information displayed in the region.

Region 510 may comprise one or more fields and/or descriptive text (labels, etc.) such as a field to indicate a date from which the derivative contract is valid. Other information may also be displayed, if desired.

Region 512 may comprise an area where a title is displayed and one or more fields, labels, and/or other descriptive text or combinations thereof displayed to indicate the contract size such as the contract quantity and/or unit of measure. For example, the contract size of the crude oil of Table 1 above is 1,000 barrels. The contract size and unit of measure will depend on the commodity of the contract. As another example, a contract for metal, such as copper or aluminum may have a unit of measure of tons, metric tons, etc. with a contract size of 25 tons, metric tons or however the contract is specified. The unit of measure may also be pulled from (or congruent with) another field, such as that specified in region 412 of FIG. 4, which describes the underlying commodity.

Region 514 may comprise an area where a title is displayed and one or more fields, labels, and/or other descriptive text or combinations thereof displayed to indicate quotation information of the derivative contract specification. For example, fields, labels and/or other descriptive text may comprise currency, to indicate the currency (such as US Dollars, Japanese Yen, etc.) of the derivative contract specification, the currency unit (such as US Dollars, US Dollars and Cents, etc.) of the quotation, the unit of measure for the quotation (e.g., Ton, Barrel, etc.), the Commodity Pricing Engine (CPE) unit of measure (such as Ton Copper or Barrel Oil, etc.), and decimal places to indicate how many decimal places should be tracked for the quotation (e.g., 6, 2, etc.)

Region 516 may comprise an area where a title is displayed and one or more fields, labels, and/or other descriptive text or combinations thereof displayed to indicate the tick information of the derivative contract specification. For example, fields, labels, descriptive text, and/or combinations thereof may comprise the market identifier code for the market, the tic size, the currency unit, the tick value and the currency of the tick value. Information in these fields, labels, descriptive text, etc. may come from, or be congruent with, other places, such as region 514, or regions of FIG. 4. For example, if copper is being traded and the unit of measure is ton with a contract size of 25 tons, 6 decimal places, and currency unit of US dollars, traded on the London Metal Exchange (MIC of XLME), the MIC may be XLME, the tic size 1.000000, the currency unit USD, the tick value 25.000000, and the tick currency of USD.

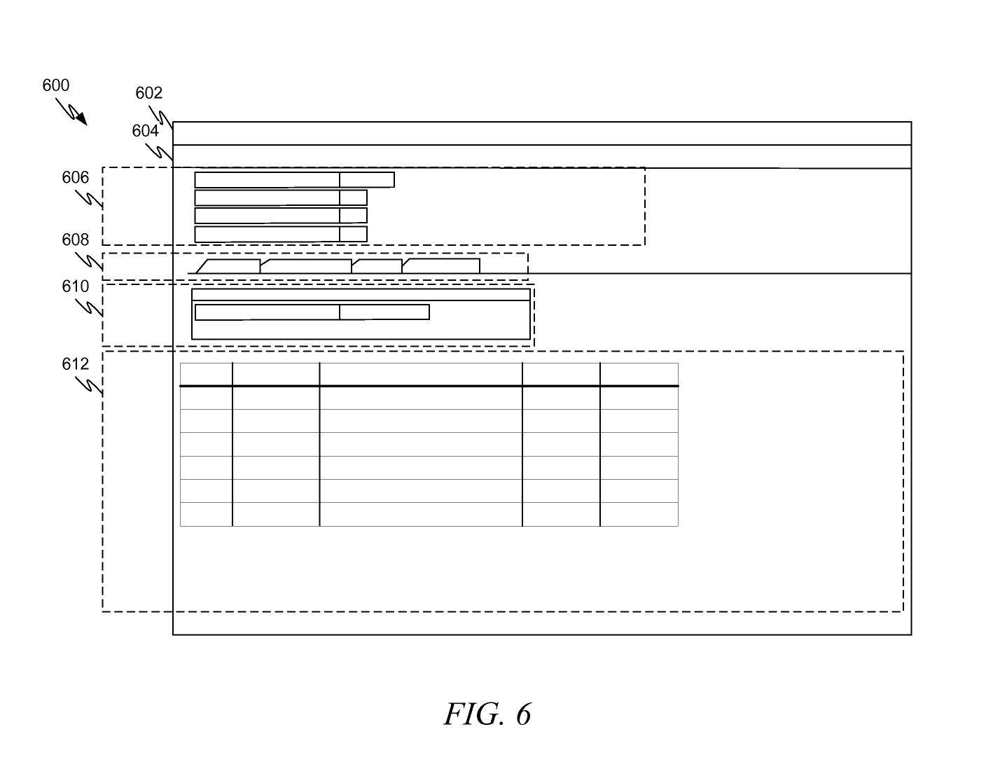

FIG. 6 illustrates a representative user interface 600 according to one embodiment. The user interface 600 may be used, for example, in entering and/or displaying information associated with a derivative contract specification. The representative user interface may comprise a plurality of regions, 602, 604, 606, 608, 610 and/or 612. Some regions may contain information related to one or more objects, such as a physical commodity object 308, contract specification object 310, and/or market identifier object 312 of FIG. 3.

Region 602 may be substantially similar to region 402 of FIG. 4 or 502 of FIG. 5 and may comprise a title, such as a window title. If the user interface 600 is used to display or enter information about a derivative contract specification, the title may be something like “Display Derivate Contract Specification.”

Region 604 may be substantially similar to region 404 of FIG. 4 or 504 of FIG. 5 and comprise a plurality of icons, text labels, and/or combinations thereof that indicate various actions a user may take. Representative actions may include functions like “create” to create a new derivative contract specification, “save” to save the information into the appropriate object(s), “copy” to copy the information to a different location, etc. Some or all of the icons/text labels displayed and actions may be different from those in region 404 or 504 to represent functionality that applies to regions 606, 608, 610 and/or 612.

Region 606 may be substantially similar to region 406 of FIG. 4 or 506 of FIG. 5 and may comprise a plurality of fields, labels, and/or descriptive text that identify the contract specification object such as a derivative contract specification identifier field to identify the contract specification object, a description field containing a description of the derivative contract, a derivative category field containing the type of derivative contract (such as futures, option, etc.), a status field containing the status of the contract specification object (e.g., released, etc.). In one embodiment, region 606 may be continuously displayed even if other regions of the user interface change when, for example, a new tab is selected as described below. However, this may not be reflected in all embodiments.

Region 608 may be substantially similar to region 408 of FIG. 4 or 508 of FIG. 5, and may comprise a plurality of tab controls that cause different regions containing different fields to be displayed in the area underneath the tabs. One tab may be highlighted, brought to the front, and/or otherwise distinguished from the other tabs to indicate which tab is being displayed in the remainder of the regions of the display. In one embodiment, the tabs may contain basic data, derivative details, periods, and administration. Some of these are described in conjunction with other figures below. When the periods tab is selected, region 610, 612 and/or combinations thereof may be displayed. Each region may contain a title indicating the information displayed in the region.

Region 610 may comprise one or more fields and/or descriptive text (labels, etc.) such as a field to indicate a date from which the period should be started. These fields and/or descriptive text may be congruent with other information in other places, such as region 510 of FIG. 5. Other information may also be displayed, if desired.

Region 612 may comprise an area where a title is displayed and one or more fields, labels, and/or other descriptive text or combinations thereof displayed to indicate periods of the derivative contract specification. These fields, labels, and/or other descriptive text or combinations thereof may be displayed as individual fields or as a table with appropriate columns/rows. The region 612 may also comprise various icons, text labels, and/or combinations thereof illustrating table tools to invoke underlying functionality that can be performed on a table such as sorting, filtering, printing, inserting rows and/or columns, deleting rows and/or columns, and so forth. Table 2 below represents an example table that may be displayed in region 612.

TABLE 2
Derivative Contract Specification Periods

| | Key Date | | | |
|---|---|---|---|---|
| Key Date | Description | Period Type | Start | End |
| Jun. 27, 2013 | Daily— | Contract Period | Jun. 27, 2013 | Jun. 27, 2013 |
| | Jun. 27, 2013 | Cash Settlement Period | Jun. 25, 2013 | Jun. 27, 2013 |
| | | Physical Settlement Period | Jun. 27, 2013 | Jun. 27, 2013 |
| | | Trading Period | Mar. 27, 2013 | Jun. 25, 2013 |
| | | Quotation Period | Mar. 27, 2013 | Jun. 25, 2013 |
| Jun. 28, 2013 | Daily— | Contract Period | Jun. 28, 2013 | Jun. 28, 2013 |
| | Jun. 27, 2014 | Cash Settlement Period | Jun. 26, 2013 | Jun. 28, 2013 |
| | | Physical Settlement Period | Jun. 28, 2013 | Jun. 28, 2013 |
| | | Trading Period | Mar. 28, 2013 | Jun. 26, 2013 |
| | | Quotation Period | Mar. 28, 2013 | Jun. 26, 2013 |

The fields of Table 2 include a key date, a description of the key date, what type of period it is, when the start and end dates of the period are. Note that these fields may be calculated or determined from information entered elsewhere. A key date is a date in combination with a derivative contract specification that identifies, for example, individual futures with a defined last trading and settlement date in a market. Each exchange may have its way of calculating these type of period dates. It may also be that different commodities may influence the dates and the way the dates are calculated. It may further be that a derivative contract specification may influence the dates and the way the dates are calculated. Thus, information such as that entered in region 414 of FIG. 4 relating to period determination methods may be used to select logic to calculate some or all of the information in Table 2 (and consequently in region 612).

Other tabs in Regions 608 of FIG. 6, 508 of FIG. 5, and/or 408 of FIG. 4 may display, allow entry and/or combinations thereof for other information.

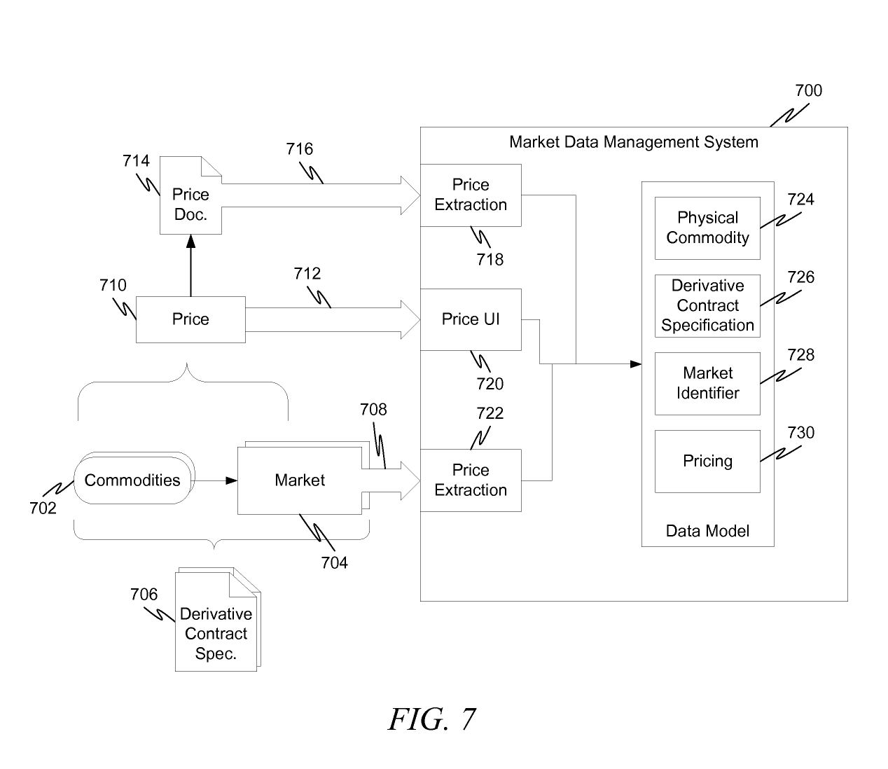

FIG. 7 illustrates representative mechanisms for entering pricing information. Commodities 702 are traded at a commodity market 704 according to a derivative contract specification 706. Embodiments of an example market data management system 700 may comprise various mechanisms for obtaining pricing information. In one embodiment, a market or other entity may publish electronic information about pricing in the form of a data feed 708 or other format. In such an embodiment, the market data management system 700 may consume the electronic data feed and extract the desired pricing information.

The pricing information may be extracted by a price extraction module 722 adapted to take in the data feed 708 and extract from the data feed information that corresponds with the physical commodity objects 724, contract specification objects 726, and market identifier objects 728 active in the system. As previously mentioned, the combination of a commodity 702, a market 704 and a derivative contract specification 706 uniquely specifies the terms and price of a commodity. Thus, the relationships between commodities represented physical commodity objects 724, the markets represented in market identifier objects 728 and the derivative contract specifications represented in contract specification objects 728 identify the information that should be extracted from data feed 708. Pricing information about the commodity may be extracted from a data feed 708 and the information captured in an appropriate data object or combination of data objects. The price may be captured as part of an existing object (e.g., a commodity object 724, a market identifier object 728, a contract specification object 726, and/or combinations thereof), or the price may be captured as part of a separate pricing object 730 and relationships between other objects may be made. In one example, the pricing object may have a 1:1 relationship with a combination of a physical commodity object 724, a contract specification object 726 and a market identifier object 728.

Pricing object 730 may comprise a plurality of data fields to identify the price of a commodity traded at a market according to a derivative contract specification. Thus, the pricing object 730 may comprise such fields as price date, price time, price type (e.g., the type of pricing information such as the spot price, etc.), the key date, the time to maturity, the quotation price, the currency of the quotation price, the quantity of the quotation price, and so forth. Time to maturity is the amount of time left until the settlement data of a future, for example, is reached. Time to maturity may be expressed in years, months or days. The pricing object may contain fields for many such quotations.

The method used by price extraction module 722 to extract information from data feed 708 may comprise a plurality of operations. One operation may identify information related to a commodity traded at a market according to a derivative contract specification. Other operation may locate within the system 700, information matching the commodity, the market and the derivative contract specification such as by identifying a contract specification object 726. Alternatively, locating information matching the commodity, the market and the derivative contract specification may be accomplished by identifying a relationship between a contract specification object 726 and another object, such as a physical commodity object 724, a market identifier object 728 or combinations thereof. Another operation may be to extract desired price information from the data feed 708 and place it in an appropriate object or combination of objects, such as pricing object 730 and/or physical commodity object 724, contract specification object 726, market identifier object 728, or combinations thereof.

As alternative to capturing information from data feed 708, market data management system 700 may allow manual entry of pricing information. A user may obtain price information 710 via various mechanisms or in a variety of formats. The market data management system 700 may then present an appropriate user interface, such as price user interface 720 and allow the user to enter the pricing information. Price user interface 720 may pull information from a variety of sources, such as physical commodity object 724, contract specification object 726, market identifier object 728, pricing object 730, and/or combinations thereof and present known information to the user. Appropriate objects and other information may be selected by the user from the user interface so that the information can be retrieved. For example, the user may be presented with a dialog allowing a user to identify a contract specification object 726 and information may then be retrieved from related objects in some embodiments. Additionally, or alternatively, the pricing user interface may include fields, labels and/or other descriptive text to allow a user to enter appropriate pricing information, such as price type, price date, price time, key date, time to maturity, etc. Note that date and time fields may include a starting and ending date, if desired.

Although not shown, market data management system 700 may also have a user interface to present commodity prices. As with the user interfaces of FIGS. 4-6, the user interface may comprise a plurality of regions. One region may include a title, such as “Commodity Prices: Display” or “Display Commodity Prices.” Another region may comprise icons, text labels, or combinations thereof associated with functionality that the user may select by clicking or otherwise activating the related icon, text label, or combination thereof. Another region may comprise general data and contain fields, labels, and/or other descriptive text such as an identifier associated with a derivative contract specification (or a contract specification objet), a market identifier, a derivative category, a physical commodity identifier (or physical commodity object identifier), and so forth. Another region may comprise a plurality of fields, labels, and/or other descriptive text that summarizes the pricing information such as yearly high, yearly low, historic high, historic low and currencies related to each. Functionality may also be indicated by icons, labels, or a combination thereof to allow a user to search, filter, set date ranges, etc. Yet another region may comprise pricing detail associated with the other information such as price date, price time, price type, key date, time to maturity, quotation price, currency, quantity or unit of measure, etc. Some or all of the regions may be set off and labeled in some fashion so a user can identify the type of information, functionality, etc. that is contained in a region, if desired.

As an alternative to capturing information from a data feed or manual data entry, market data management system 700 may import pricing information from a document 714 containing pricing information. For example, all the appropriate information may be collected into a spreadsheet and the spreadsheet document imported into the system as shown by arrow 716.

Price extraction module 718 may be adapted to extract information from a spreadsheet and place it in appropriate data object(s). Price extraction module 718 may be the same as, or different from price extraction module 722. The method used by price extraction module 718 to extract and import price information may comprise a plurality of operations. One operation may identify information related to a commodity traded at a market according to a derivative contract specification by parsing the input file. Other operation may locate within the system 700, information matching the commodity, the market and the derivative contract specification such as by identifying a contract specification object 726. Alternatively, locating information matching the commodity, the market and the derivative contract specification may be accomplished by identifying a relationship between a contract specification object 726 and another object, such as a physical commodity object 724, a market identifier object 728 or combinations thereof. Another operation may be to extract desired price information from the pricing document 714 and place it in an appropriate object or combination of objects, such as pricing object 730 and/or physical commodity object 724, contract specification object 726, market identifier object 728, or combinations thereof.

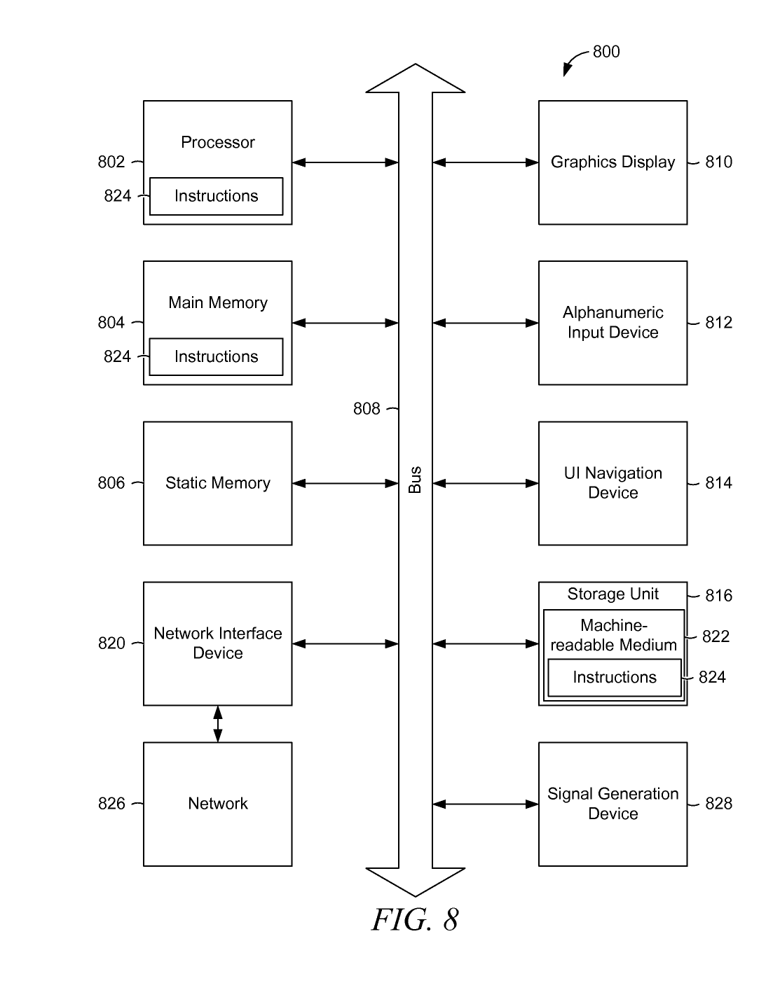

FIG. 8 is a block diagram of a computer processing system 800, within which a set of instructions 824 for causing the computer to perform any one or more of the methodologies discussed herein, may be executed.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

In addition to being sold or licensed via traditional channels, embodiments may also, for example, be deployed by Software-as-a-Service (SaaS), Application Service Provider (ASP), or utility computing providers. The computer may be a server computer, a personal computer (PC), a tablet PC, a set-top box (STB), a personal digital assistant (PDA), cellular telephone, or any processing device capable of executing a set of instructions 824 (sequential or otherwise) that specify actions to be taken by that device. Further, while only a single computer is illustrated, the term “computer” shall also be taken to include any collection of computers that individually or jointly execute a set (or multiple sets) of instructions 824 to perform any one or more of the methodologies discussed herein.

The example computer processing system 800 includes a processor 802 (e.g., a central processing unit (CPU), a graphics processing unit (GPU), advanced processing unit (APU) or some combination thereof), a main memory 804 and static memory 806, which may communicate with each other via a bus 808. The computer processing system 800 may further include a graphics display 810 (e.g., a plasma display, a liquid crystal display (LCD) or a cathode ray tube (CRT) or other display). The processing system 800 may also include an alphanumeric input device 812 (e.g., a keyboard), a user interface (UI) navigation device 814 (e.g., a mouse, touch screen, or the like), a storage unit 816, a signal generation device 818 (e.g., a speaker), and/or a network interface device 820.

The storage unit 816 includes machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer processing system 800, with the main memory 804 and the processor 802 also constituting computer-readable, tangible media.

The instructions 824 may be transmitted or received over a network 826 via a network interface device 820 utilizing any one of a number of well-known transfer protocols (e.g., HTTP).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions 824. The term “machine-readable medium” shall also be taken to include any medium that is capable of storing, encoding or carrying a set of instructions 824 for execution by the computer and that cause the computer to perform any one or more of the methodologies of the present application, or that is capable of storing, encoding or carrying data structures utilized by or associated with such a set of instructions 824. The term “machine-readable medium” shall accordingly be taken to include, but not be limited to, solid-state memories, and optical and magnetic media. The term “machine-readable storage medium” does not include signals or other intangible mechanisms. Such intangible media will be referred to as “machine-readable signal media.” The term “machine-readable media” will encompass both “machine-readable storage media” and “machine-readable signal media.”

While various implementations and exploitations are described, it will be understood that these embodiments are illustrative and that the scope of the claims is not limited to them. In general, techniques for maintaining consistency between data structures may be implemented with facilities consistent with any hardware system or hardware systems defined herein. Many variations, modifications, additions, and improvements are possible.

While the embodiments are described with reference to various implementations and exploitations, it will be understood that these embodiments are illustrative, and that the scope of claims provided below is not limited to the embodiments described herein. In general, the techniques described herein may be implemented with facilities consistent with any hardware system or hardware systems defined herein. Many variations, modifications, additions, and improvements are possible.

The term “computer readable medium” is used generally to refer to media embodied as non-transitory subject matter, such as main memory, secondary memory, removable storage, hard disks, flash memory, disk drive memory, CD-ROM and other forms of persistent memory. It should be noted that program storage devices, as may be used to describe storage devices containing executable computer code for operating various methods, should not be construed to cover transitory subject matter, such as carrier waves or signals. “Program storage devices” and “computer-readable medium” are terms used generally to refer to media such as main memory, secondary memory, removable storage disks, hard disk drives, and other tangible storage devices or components.

Plural instances may be provided for components, modules, operations, or structures described herein as a single instance. Finally, boundaries between various components, modules, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure, module, or component. Similarly, structures and functionality presented as a single module or component may be implemented as separate modules or components. These and other variations, modifications, additions, and improvements fall within the scope of the claims and their equivalents.

What is claimed is:

1. A method comprising:
storing a physical commodity object comprising a first plurality of data fields to identify a real world commodity;
storing a market identifier object comprising a market identifier code to identify a commodity market;
storing a contract specification object comprising a second plurality of data fields corresponding to information associated with a derivative contract specification for the real world commodity and the commodity market; and
creating an association between the physical commodity object, the market identifier object and the contract specification object such that the combination of the physical commodity object, the market identifier object and the contract specification object together describe the real world commodity traded at the commodity market according to the derivative contract specification.

2. The method of claim 1, the first plurality of data fields of the physical commodity object comprise a physical commodity identifier, a physical commodity description, and a physical commodity unit of measure.

3. The method of claim 2 wherein the association between the physical commodity object, the market identifier object and the contract specification object comprises the market identifier of the market identifier object and the physical commodity identifier.

4. The method of claim 1 wherein the second plurality of data fields corresponding to information associated with the derivative contract specification comprises data fields associated with one of a plurality of different financial derivatives.

5. The method of claim 1, wherein the second plurality of data fields corresponding to information associated with the derivative contract specification comprises a commodity quotation unit of measure, a contract quantity, and a currency.

6. The method of claim 1, further comprising entering pricing information for the real world commodity.

7. The method of claim 1, further comprising presenting a user interface to display and receive information, the user interface having a plurality of regions comprising:
a first user interface region to display a derivative contract specification identifier associated with the derivative contract specification;
a second user interface region displaying a plurality of tabs, each tab displaying a different set of fields when selected, the plurality of tabs comprising:
a basic data tab to display basic data regarding the derivative contract specification;
a derivative detail tab to display details regarding the derivative contract specification; and
a periods tab to display time periods associated with the derivative contract specification.

8. A system comprising:
memory;
a computer processor coupled to the memory;
instructions stored in the memory and executable by the processor, the instructions configuring the machine to model real world commodity information by configuring the machine to:
store a physical commodity object comprising a first plurality of data fields to identify a real world commodity;
store a market identifier object comprising a market identifier code to identify a commodity market;
store a contract specification object comprising a second plurality of data fields corresponding to information associated with a derivative contract specification for the real world commodity and the commodity market; and
create an association between the physical commodity object, the market identifier object and the contract specification object such that the combination of the physical commodity object, the market identifier object and the contract specification object together describe the real world commodity traded at the commodity market according to the derivative contract specification.

9. The system of claim 8, wherein the instructions configure the machine to store a plurality of physical commodity objects, each representing a different real world commodity, a plurality of market identifier objects, each representing a different commodity market and a plurality of contract specification objects, each representing different contract specification.

10. The system of claim 9, wherein the instructions configure the machine to create relationships between one physical commodity object and multiple contract specification objects.

11. The system of claim 9, wherein the instructions configure the machine to create relationships between one market identifier objects and multiple contract specification objects.

12. The system of claim 8, wherein the first plurality of data fields of the physical commodity object comprise a physical commodity name, a physical commodity description, and a physical commodity unit of measure.

13. The system of claim 8, wherein the second plurality of data fields of the contract specification object comprise a commodity quotation unit of measure, a contract quantity, and a currency.

14. The system of claim 8, wherein the instructions configure the machine to present a user interface to display and receive information, the user interface including a plurality of regions comprising:
a first user interface region to display a derivative contract specification identifier associated with the derivative contract specification;
a second user interface region displaying a plurality of tabs, each tab displaying a different set of fields when selected, the plurality of tabs comprising:
a basic data tab to display basic data regarding the derivative contract specification;
a derivative detail tab to display details regarding the derivative contract specification; and
a periods tab to display time periods associated with the derivative contract specification.

15. A machine-readable storage medium comprising instructions that, when executed by at least one processor of a machine, configure the machine to:
store a physical commodity object comprising a first plurality of data fields to identify a real world commodity;
store a market identifier object comprising a market identifier code to identify a commodity market; and
store a contract specification object comprising:
a reference to the physical commodity object;
a reference to the market identifier object; and
a second plurality of data fields corresponding to information associated with a derivative contract specification for the real world commodity and the commodity market.

16. The machine-readable storage medium of claim 15, wherein the instructions further configure the machine to:
store a pricing location object describing a location;
store a generic commodity object containing a generic commodity description; and
store a real commodity object containing the real world commodity description.

17. The machine-readable storage medium of claim 15, wherein the instructions further configure the machine to present a user interface to display and receive information, the user interface comprising a plurality of regions comprising:
a first user interface region to display a derivative contract specification identifier associated with the derivative contract specification;
a second user interface region displaying a plurality of tabs, each tab displaying a different set of fields when selected, the plurality of tabs comprising:
a basic data tab to display basic data regarding the derivative contract specification;
a derivative detail tab to display details regarding the derivative contract specification; and
a periods tab to display time periods associated with the derivative contract specification.

18. The machine-readable storage medium of claim 17, wherein the basic data tab contains a plurality of fields comprising:
a commodity symbol;
a link to the derivative contract specification;
an identifier associated with the physical commodity object; and
at least one data field specifying how information under the periods tab will be calculated.

19. The machine-readable storage medium of claim 17, wherein the derivative detail tab contains a plurality of fields comprising:
a commodity quotation unit of measure;
a contract quantity; and
a currency.

20. The machine-readable storage medium of claim 17, wherein the periods tab contains a table comprising:
a key date column;
a key date description column;
a period type column containing at least one period type;
a start date column containing a start date for the at least one period type; and
an end date column containing an end date for the at least one period type.
